(19) United States
(12) Patent Application Publication
(10) Pub. No.: US 2007/0072654 A1
(43) Pub. Date: Mar. 29, 2007

(54) Multi speaker two part electronics device

(76) Inventor: Steven John Cosgrove, Singapore (SG)

Correspondence Address: MOTOROLA INC, 600 NORTH US HIGHWAY 45, ROOM AS437, LIBERTYVILLE, IL, 60048-5343, US

(21) Appl. No.: 11/236,332

(22) Filed: Sep. 27, 2005

(51) Int. Cl. H04M 1/00

(52) U.S. Cl. 455/575.2; 455/569.1

(57) ABSTRACT

A multi-speaker two part electronics device (100) with a first housing portion (110) with a first speaker. A first ear mount (255) is attached to the first housing portion (110), the first ear mount (225) being shaped to mount the first housing portion (110) to an ear of a user. A second housing portion (160) is releasbly mountable to the first housing portion (110), There is a second speaker mounted in the second housing portion (160) and a second ear mount (255) is attached to the second housing portion (160). The second ear mount (255) is shaped to mount the second housing portion (160) to an ear of the user.

### FIELD OF THE INVENTION

This invention relates in general to a multi speaker two part electronics device with stereophonic capabilities. The invention is particularly useful for, but not necessarily limited to, portable electronics devices such as two-part radio communications devices with a two-part housing portions releasbly mounted to each other.

### BACKGROUND OF THE INVENTION

Portable communications devices such as cellular telephones are becoming commonplace in society. With increasing use of such devices there has been a demand for increased functionality and greater compactness for ease and convenience of use. Customarily, these portable communications devices accompany users most of the time and recently there has been a trend towards providing multimedia entertainment capabilities including music playing features and video content playing features on such devices. These multimedia entertainment capabilities may allow for multimedia content to be transmitted to the device remotely, for instance by Frequency Modulated (FM) radio or video streaming. Alternatively, the multimedia content may be stored in permanent memory on the device typically in MPEG, MP3 or any other suitable format.

When playing audio multimedia content such as music, a user typically uses a stereo headset that is coupled by wiring, or a radio link, to the device. Such headsets may be inconvenient as the user may forget to bring the headset with them and also the headset typically has to be stored away when not required.

### SUMMARY OF THE INVENTION

According to one aspect of the invention there is provided a multi-speaker two part electronics device comprising:

a first housing portion with a first speaker mounted therein,

a first ear mount attached to the first housing portion, the first ear mount being proximal to the first speaker, and the first ear mount being shaped to mount the first housing portion to an ear of a user;

a second housing portion releasbly mountable to the first housing portion, the second housing portion having a second speaker mounted therein; and

a second ear mount attached to the second housing portion, the second ear mount being proximal to the second speaker, and the second ear mount being shaped to mount the second housing portion to an ear of the user.

Suitably, the first ear mount and second ear mount can be located at opposite ends of a housing comprising the first housing portion and second housing portion. Suitably, the first ear mount can be a shouldered rim.

The first ear mount may suitably be an ear hook. The first ear mount can be locatable in a first recess formed in the first housing portion and the second ear mount is locatable in a second recess formed in the second housing portion. Suitably, the second housing portion may be releasbly mounted to the first housing portion at a hinge, the hinge allowing for relative pivotal movement of the second housing portion relative to the first housing portion. The first ear mount may be located at a free end of the first housing portion and the second and second ear mount is located at a free end of the second housing portion.

Suitably, the first housing portion may have a primary radio frequency communications unit mounted therein, the primary radio frequency communications unit providing wireless communication with a telephone network. There may be audio signal providing circuitry operatively coupled to the first speaker and second speaker.

Suitably, there may be a microphone associated with the first housing, the microphone being operatively coupled to the primary radio frequency communications unit. Suitably, there may be a keypad mounted to the first housing member, the keypad being operatively coupled to the audio signal providing circuitry. There may be a display screen mounted to the first housing member, the display screen being operatively coupled to the audio signal providing circuitry.

Suitably, the first housing portion may have a secondary radio frequency communications unit mounted therein; and the second housing portion has a short range radio frequency communications unit mounted therein, the short range radio frequency communications unit providing radio communication with the secondary radio frequency communications unit. The secondary radio frequency communications unit can be operatively coupled to the audio signal providing circuitry.

According to another aspect of the invention, there is provided a multi-speaker two part electronics device comprising:

a first housing portion with a first speaker mounted therein, the first speaker being adjacent an associated first speaker aperture in the first housing,

a first ear hook attached to the first housing portion, the first ear hook at least partially surrounding the first speaker aperture;

a second housing portion releasbly mountable to the first housing portion, the second housing portion having a second speaker mounted therein, the second speaker being adjacent an associated second speaker aperture in the second housing; and

a second ear hook attached to the second housing portion, the second ear hook at least partially surrounding the second speaker aperture.

The first ear hook and second ear hook may be located at opposite ends of a housing comprising the first housing portion and second housing portion. Suitably, the first ear hook may be locatable in a first recess formed in the first housing portion and the second ear hook is locatable in a second recess formed in the second housing portion.

The second housing portion can be releasbly mounted to the first housing portion at a hinge, the hinge allowing for relative pivotal movement of the second housing portion relative to the first housing portion.

Suitably, the first housing portion may have a primary radio frequency communications unit mounted therein, the primary radio frequency communications unit providing wireless communication with a telephone network. There may be audio signal providing circuitry operatively coupled to the first speaker and second speaker.

### BRIEF DESCRIPTION OF THE DRAWINGS

In order that the invention may be readily understood and put into practical effect, reference will now be made to exemplary embodiments as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic block diagram of a two-part electronics device in accordance with a first embodiment of the invention;

FIG. 2 is a perspective view of housing portions of the two-part radio communications device of FIG. 1, the housing portions being in mounted together in an opened position;

FIG. 3 is a plan view of the housing portions of the two-part radio communications device of FIG. 1, the housing portions being in mounted together in a closed position;

FIG. 4 is a perspective view of the housing portions of the two-part a radio communications device of FIG. 1, the housing portions being physically detached from each other;

FIG. 5 is a cross sectional view through 3-3 of FIG. 3;

FIG. 6 illustrates the housing portions of the device of FIG. 1 when mounted to respective ears of a user;

FIG. 7 is a perspective view of the housing portions of the two-part radio communications device of FIG. 1, the housing portions being mounted together in a closed position;

FIG. 8 is a perspective view of alternative housing portions of the two-part radio communications device of FIG. 1, the housing portions being in mounted together in an opened position;

FIG. 9 is a schematic block diagram of a two-part electronics device in accordance with a second embodiment of the invention;

FIG. 10 is a perspective view of the housing portions of the two-part a radio communications device of FIG. 9, the housing portions being physically detached from each other; and

FIG. 11 illustrates the housing portions of the device of FIG. 9 when mounted to respective ears of a user.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of components related to a two-part multi speaker electronics device with stereophonic capabilities. Accordingly, the device components and have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a device that comprises a list of elements does not include only those elements but may include other elements not expressly listed or inherent to such a device.

It will be appreciated that embodiments of the invention described herein may be comprised of one or more conventional processors and unique stored program instructions that control the one or more processors to implement, in conjunction with certain non-processor circuits, some, most, or all of the functions of the two-part multi speaker electronics device with stereophonic capabilities described herein. The non-processor circuits may include, but are not limited to, a radio receiver, a radio transmitter, signal drivers, clock circuits, power source circuits, and user input devices. As such, these functions may be interpreted as steps of a method to perform {replace with a technical description of the invention in a few words}. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

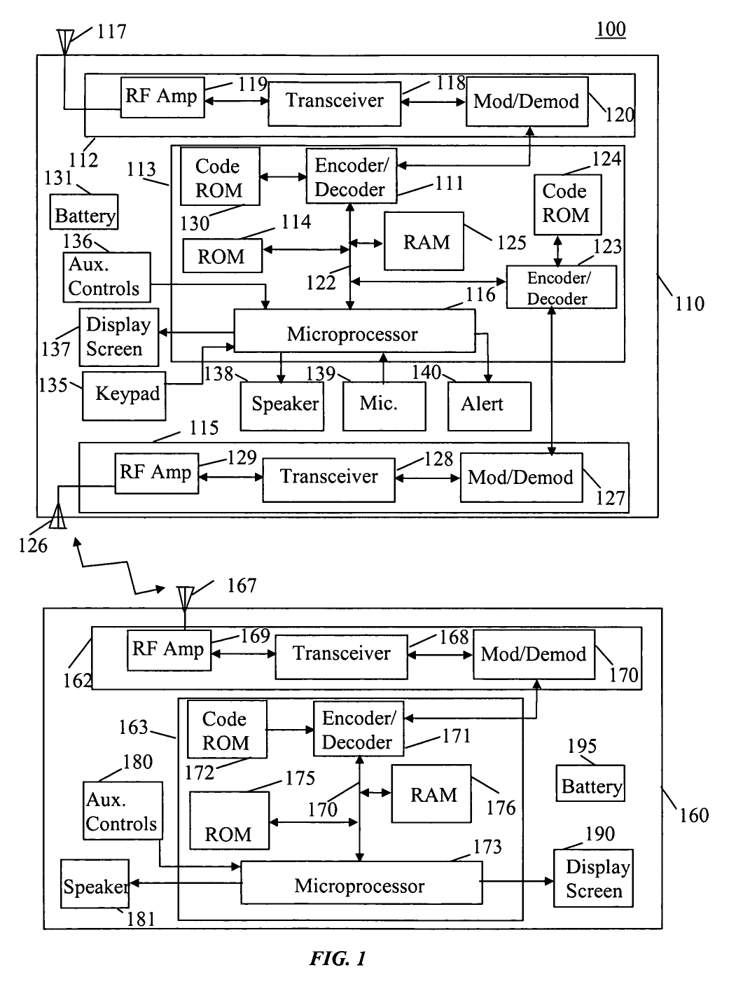

In the drawings, like numerals on different Figs are used to indicate like elements throughout. With reference to FIG. 1, there is illustrated a schematic block diagram of a first embodiment of a two-part multi speaker electronics device with stereophonic capabilities in the form of a radio communications device 100 comprising a first housing portion 110 and a second housing portion 160. Housed in or associated with the first housing portion 110 is a primary radio frequency communications unit 112 providing wireless communication with a telephone network as will be apparent to a person skilled in the art. The first housing portion 110 also houses a secondary radio frequency communications unit 115 and both the primary radio frequency communications unit 112 and secondary radio frequency communications unit 115 are operatively coupled to be in communication with a primary processor 113. The processor 113 includes a primary encoder/decoder 111 with an associated Code Read Only Memory (ROM) 130 storing data for encoding and decoding voice, music or other signals that may be transmitted or received by primary radio frequency communications unit 112. The processor 113 also includes a micro-processor 116 operatively coupled, by a bus 122, to the primary encoder/decoder 111, a Read Only Memory (ROM) 114, a Random Access Memory (RAM) 125 and a secondary encoder/decoder 123 having an associated Code ROM 124.

The Read only memory (ROM) 114 stores multi-media content (including music) and operating code (OC) for micro-processor 116 to run the basic functions associated with the device 100. The primary radio frequency communications unit 112 is a combined receiver and transmitter having a common antenna 117. The primary radio frequency communications unit 112 has a transceiver 118 coupled to antenna 117 via a radio frequency amplifier 119. The transceiver 118 is also coupled to a combined primary modulator/demodulator 120 that couples the communications unit 112 to the processor 113. Also, the secondary radio frequency communications unit 115 has a transceiver 128 coupled to an antenna 126 via a radio frequency amplifier 129. The transceiver 128 is also coupled to a secondary modulator/demodulator 127 that couples the secondary radio frequency communications unit 115 to the processor 113.

Coupled to the micro-processor 116 are a keypad 135, auxiliary controls 136, a first display screen 137, a first speaker 138, a microphone 139 and an alert signal generator 140. Typically, the display screen 137 may be a touch screen and the keypad 135 may be a virtual keypad on the touch screen and therefore in such case the keypad 135 would be optional. Also, the first speaker 138 and the microphone 139 are operatively coupled through the processor 113 to the primary radio frequency communications unit 112 to provide for voice communications, for example, with another communications device coupled to a telephone network to which the device 100 is registered. There is also a battery compartment 131 for storing battery cells for providing power to circuitry and components described above that are housed in the first housing portion 110. The power lines from the battery compartment 131 are not shown but will be apparent to a person skilled in the art.

Housed in or associated with the second housing portion 160 is a short range communications unit 162 providing radio communications with the secondary radio frequency communications unit 115. The short range communications unit 162 is operatively coupled to be in communication with a secondary processor 163. The secondary processor 163 includes an interface encoder/decoder 171 with an associated Code Read Only Memory (ROM) 172 storing data for encoding and decoding voice, music content signals and multimedia signals, or other signals that may be transmitted or received by short range communications unit 162. The secondary processor 163 also includes a micro-processor 173 operatively coupled, by a bus 170, to the encoder/decoder 171, a Read Only Memory (ROM) 175 and a Random Access Memory (RAM) 176.

The short range communications unit 162 has a transceiver 168 coupled to an antenna 167 via a radio frequency amplifier 169. The transceiver 168 is also coupled to a combined modulator/demodulator 170 that couples the communications unit 162 to the secondary processor 163.

Coupled to the micro-processor 173 are auxiliary controls 180, a second display screen 190 and a second speaker 181. The second housing portion 160 also includes a battery compartment 195 for storing battery cells for providing power to circuitry and components described above that are housed in the second housing portion 160. The power lines from the battery compartment 195 are not shown but will be apparent to a person skilled in the art.

It will be appreciated that in addition to performing conventional radio communications processing device functions, the processor 113 is programmed to operate as a multimedia provider and thus one function provided by the processor 113 is that of audio signal providing circuitry (ASPC). This audio signal providing circuitry ASPC typically includes the microprocessor 116, ROM 114 and RAM 125, wherein the ROM 114 is a programmable device capable of storing loaded music content in any convenient format such as MP3 format. The first speaker 138, first display screen 137 and keypad 135 are directly operatively coupled to the audio signal providing circuitry ASPC. Also, the second speaker 181 is operatively coupled to the audio signal providing circuitry ASPC through short range wireless/radio communications provided by the secondary radio frequency communications unit 115, that is coupled to the audio signal providing circuitry ASPC, and the short range radio frequency communications unit 162.

As will be apparent to a person skilled in the art, the first speaker 138 and second speaker 181 may include more tha just an electric signal to sound transducer. The speakers 138 and 181 may each include a power amplifier and digital to analogue converter. Alternatively, respective output ports of microprocessors 116 and 173 may each include a power amplifier and digital to analogue converter.

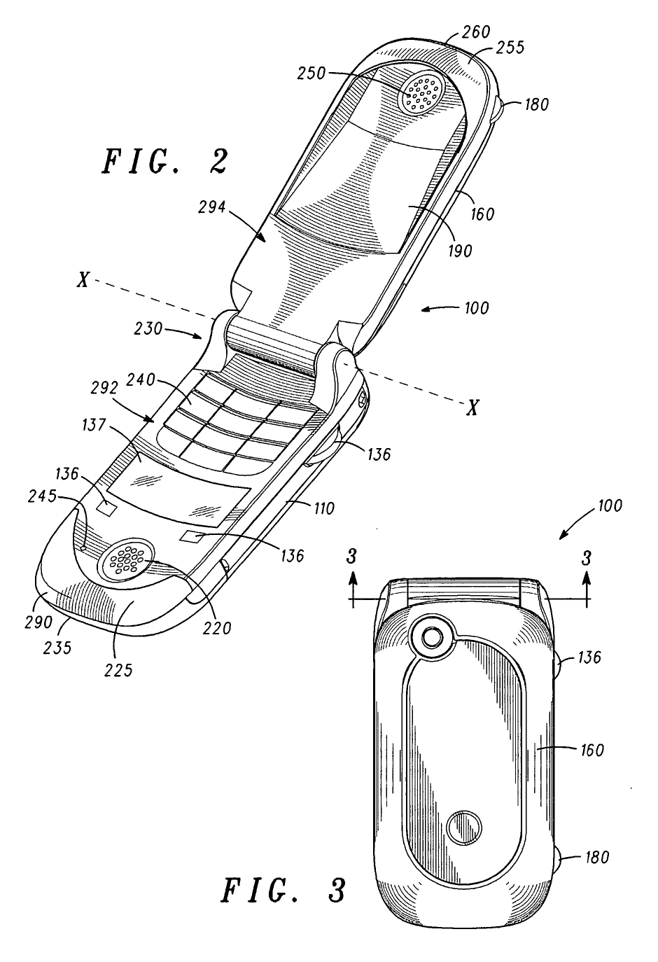

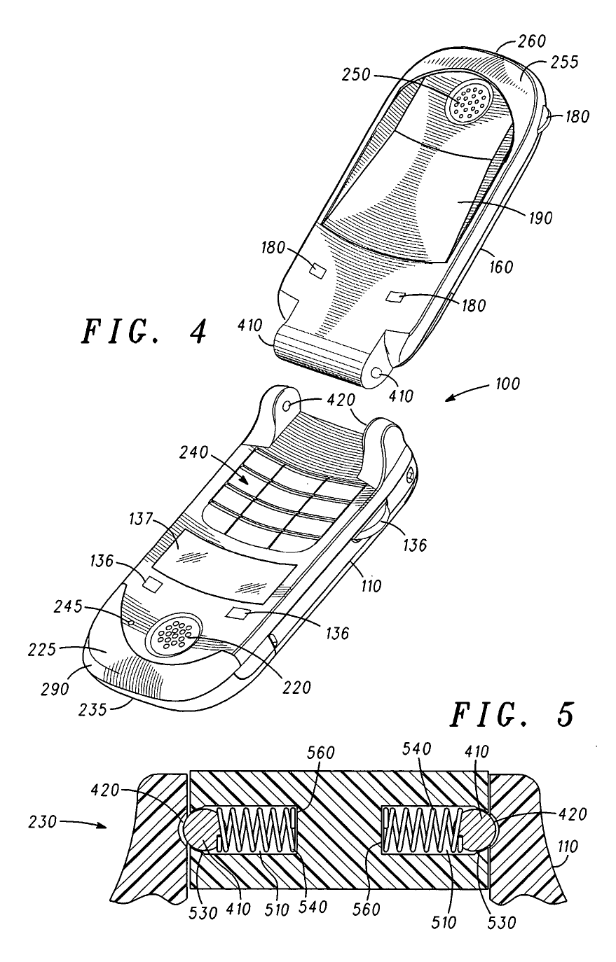

Referring to FIG. 2 to 7 there is illustrated the first and second housing portions 110, 160 of the device 100. The first housing potion 110 has the first speaker 138 mounted therein at a position directly underneath a first speaker grille 220 located in a first inner face 292. There is also a first ear mount 225 attached or fixed to the first housing portion, the first ear mount being proximal to the first speaker 138 and grille 220. The second housing portion 160 is releasbly mounted to the first housing portion 110 at a hinge assembly 230, the hinge assembly 230 provides for allowing for relative pivotal movement of the second housing portion 160 relative to the first housing portion 110 about a pivotal axis X from an opened to a closed position.

The first ear mount 225 is a shouldered rim located at a free end 235 of the first housing portion 110, the shouldered rim typically being integrally moulded with the first housing portion 110. Furthermore, there is a tapered recess 290 in an outer surface of the first ear mount 225. Also, as illustrated, mounted in or on the first housing portion 100 and visible are keys 240 associated with the keypad 135, the first display screen 137, auxiliary controls 136, a microphone aperture 245 aligned with the microphone 139 that is inside the first housing portion 110.

The second housing potion 160 has the second speaker 181 mounted therein at a position directly underneath a second speaker grille 250 located in a second inner face 294. There is also a second ear mount 255 attached or fixed to the second housing portion 160, the second ear mount 255 being proximal to the second speaker 181 and grille 250.

The second ear mount 255 is a shouldered rim located at a free end 260 of the second housing portion 160, the shouldered rim typically being integrally moulded with the second housing portion 160. Also, as illustrated, mounted in or on the second housing portion 160 and visible are the second display screen 190 and auxiliary controls 180.

The first ear mount 225 and second ear mount 255 are located at respective opposite free ends 235, 260 of a housing comprising the first housing portion 110 and second housing portion 160. The second housing portion 160 is releasbly mounted to the first housing portion 110 at the hinge assembly 230, more specifically the second housing portion 160. is releasbly mounted at the pivotal axis X by spring loaded balls 410 engaging and disengaging respective sockets 420 forming part of the hinge assembly 230. The structure and relationship of the spring loaded balls 410 when engaging and the respective sockets 420 is illustrated specifically in FIG. 5. As shown, the balls (ball bearings) 410 are located in recesses 510 that are co-axial with the pivotal axis X. The balls 410 are biased towards their respective sockets 420 and partially protrude out of the recesses 510 due to biasing provided by respective compression springs 540 co-acting with an end surface 560 of their respective recesses 510. Further, necks 530 at openings of the recesses 510 provide for retaining the balls 410 in the recesses 510. As will be apparent to a person skilled in the art, the second housing portion 160 is formed from two sub portions, and therefore the balls 410 and springs 540 are simply located in their respective recesses 510 prior to the two sub portions being attached together.

The device 100 advantageously provides for releasably mounting of the second housing portion 160 from the first housing portion 110, when the portions 110, 160 are physically detached from each other the first ear mount 225 is so shaped and thereby adapted to mount the first housing portion 110 to an ear of a user 600. Also, the second ear mount 255 is so shaped and thereby adapted to mount the second housing portion 160 to an ear of the user 600. Hence, the invention provides for allowing the housing portions 110, 160 to be mounted to respective ears of the user 600, so that when mounted the speaker grilles 220, 250 are located adjacent the ears of the user 600.

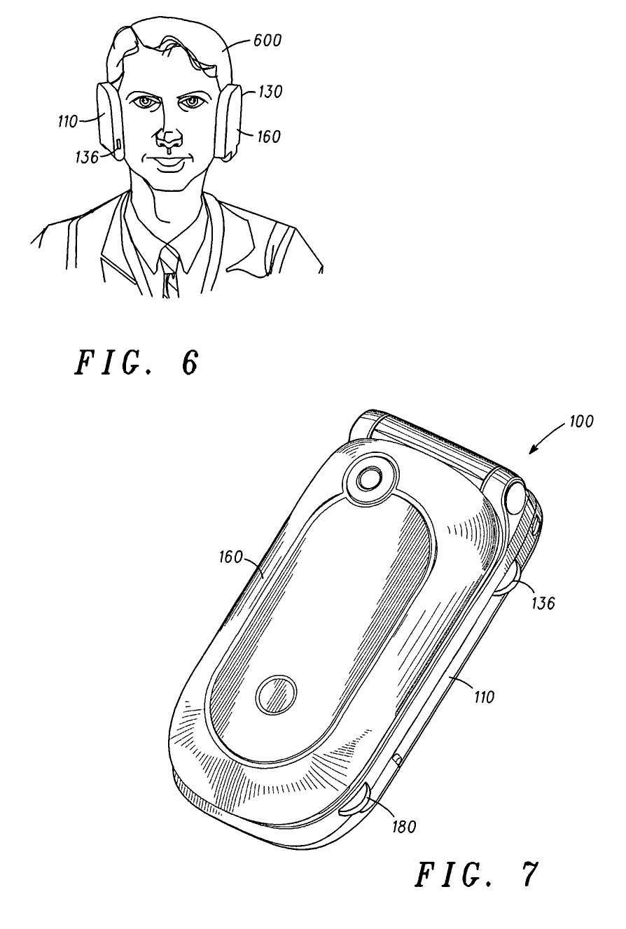

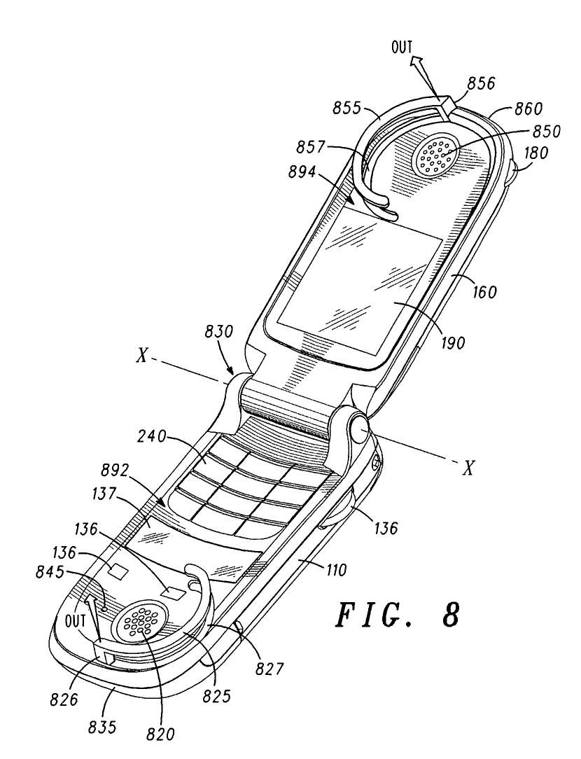

In use, music content stored in the ROM 114 can be played by the device 100 when it is worn by the user 600 as shown in FIG. 6. Thus stereophonic music can be enjoyed and the user 600 can adjust the volume and content being played by use of auxiliary controls 136 or 180. The content is transferred from ROM 114 to the second speaker 181 in housing portion 160 via a short range radio frequency link (RFL) provided by the short range radio frequency communications unit 162 and secondary radio frequency communications unit 115. Furthermore, the auxiliary controls 180 can send control signals over the short range radio frequency link RFL to, for instance, answer an incoming telephone call, make an outgoing telephone call, select music content, and adjust music content volume played in both speakers 138, 181. It is envisaged that the device 100 is worn, the user 600 can answer an incoming call by actuation of the auxiliary controls 180 or 136 (or a call can be automatically answered upon receipt thereof) and music content can be automatically place on pause for the duration of the call. For a clearer reception of the voice of the user 600 during a call, there may be an auxiliary microphone (not shown) in the first housing portion 110 located adjacent the hinge assembly 230.

Typically, the device 100 is usually in the closed position as shown in FIG. 7 when it is not being used, for instance, to play multi-media content such a music or communicate over a telephone network, When in the closed position, the second ear mount 255 at least partially fits into the tapered recess 255 thereby allowing the inner faces 292, 294 of the device 100 to be substantially parallel to each other. As a result, the ear mounts 225,255 do not unduly restrict or limit the closing of the device 100.

Referring to FIG. 8 there is illustrated a perspective view of alternative housing portions 110, 160 of the two-part radio communications device 100, the housing 110, 160 portions being in mounted together in an opened position. The first housing potion 110 has the first speaker 138 mounted therein at a position directly underneath a first speaker grille 820 located in a first inner face 892. There is also a first ear mount in the form of a first ear hook 825 slidably mounted (attached) to the first housing portion 110. The first ear hook 825 is proximal to the first speaker 138 that has an adjacent aligned associated grille 820 comprising at least one aperture in the first housing portion 110. As shown, the first ear hook 825 partially surrounds the grille 820. The first ear hook 825 is locatable in a complementary shaped recess 827 and is movable out of the recess 827 in a direction illustrated by arrowed line OUT by a user concurrently pressing and pulling on a lateral shoulder 826 of the first ear hook 825. The first ear hook 825 can be inserted back into the recess 827 by simply pushing on its outer surface in a direction opposite to that of the arrowed line OUT. The second housing portion 160 is releasbly mounted to the first housing portion 110 at a hinge assembly 830, a hinge assembly 830 again provides for allowing for relative pivotal movement of the second housing portion 160 relative to the first housing portion 110 about a pivotal axis X from an opened to a closed position.

The second housing potion 160 has the second speaker 181 mounted therein at a position directly underneath a second speaker grille 850 located in a second inner face 894. There is also a second ear mount 255 fixed to the second housing portion 160, the second ear mount in the form of a second ear hook 255 slidably mounted (attached) to the second housing portion 190. The second ear hook 855 is proximal to the second speaker 181 that has an adjacent aligned associated grille 850 comprising at least one aperture in the second housing portion 160. As shown, the second ear hook 255 partially surrounds the grille 850. The second ear hook 855 is locatable in a complementary shaped recess 857 and is movable out of the recess 857 in a direction illustrated by arrowed line OUT by a user concurrently pressing and pulling on a lateral shoulder 866 of the second ear hook 855. The second ear hook 855 can be inserted back into the recess 857 by simply pushing on its outer surface in a direction opposite to that of the arrowed line OUT. Hence, since the ear hooks 825, 855 are locatable in their respective recesses 827, 857, there is no unduly restriction or limitation of the closing of the device 100.

All other features, components, benefits, advantages and components of the device of FIG. 8 are the same as those in the preceding described figures and therefore to avoid repetition are not described again.

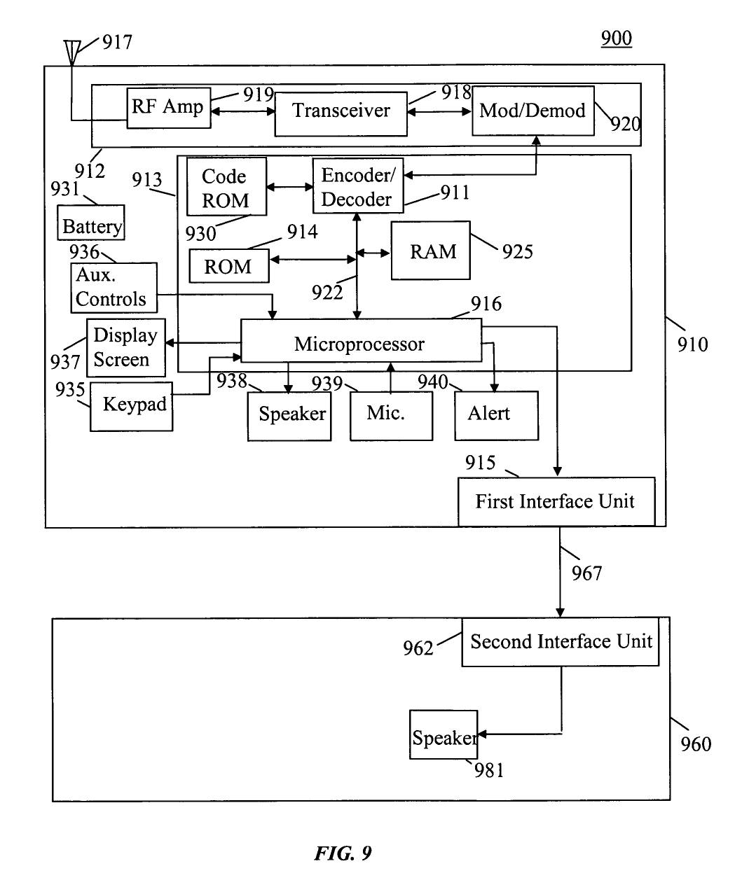

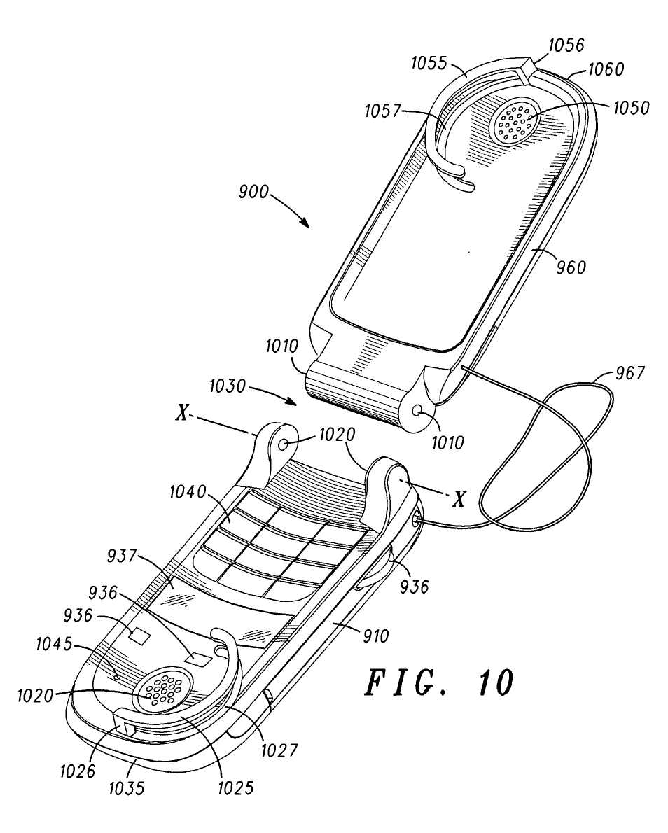

Referring to FIG. 9 there is illustrated a schematic block diagram of a second embodiment of a two-part multi speaker electronics device with stereophonic capabilities in the form of a radio communications device 900 comprising a first housing portion 910 and a second housing portion 960.

Housed in or associated with the first housing portion 910 is a primary radio frequency communications unit 912 providing wireless communication with a telephone network as will be apparent to a person skilled in the art. The first housing portion 910 also houses a first interface unit 915 and both the primary radio frequency communications unit 912 and first interface unit 915 are operatively coupled to be in communication with a processor 913. The processor 913 includes an encoder/decoder 911 with an associated Code Read Only Memory (ROM) 930 storing data for encoding and decoding voice, music or other signals that may be transmitted or received by primary radio frequency communications unit 912. The processor 913 also includes a micro-processor 916 operatively coupled, by a bus 922, to the encoder/decoder 911, a Read Only Memory (ROM) 914 and a Random Access Memory (RAM) 925.

The Read only memory (ROM) 914 stores multi-media content (including music) and operating code (OC) for micro-processor 916 to run the basic functions associated with the device 900. The primary radio frequency communications unit 912 is a combined receiver and transmitter having a common antenna 917. The primary radio frequency communications unit 912 has a transceiver 918 coupled to antenna 917 via a radio frequency amplifier 919. The transceiver 918 is also coupled to a combined primary modulator/demodulator 920 that couples the communications unit 912 to the processor 913.

Coupled to the micro-processor 916 are a keypad 935, auxiliary controls 936, a display screen 937, a first speaker 938, a microphone 939 and an alert signal generator 940. Typically, the display screen 937 may be a touch screen and the keypad 935 may be a virtual keypad on the touch screen and therefore in such case the keypad 935 would be optional. Also, the first speaker 938 and the microphone 939 are operatively coupled through the processor 913 to the primary radio frequency communications unit 912 to provide for voice communications, for example, with another communications device coupled to a telephone network to which the device 900 is registered. There is also a battery compartment 931 for storing battery cells for providing power to circuitry and components described above that are housed in the first housing portion 910. The power lines from the battery compartment 931 are not shown but will be apparent to a person skilled in the art.

Housed in or associated with the second housing portion 960 is a second interface unit 962 coupled to a second speaker 981, the second interface unit 962 providing communications with the first interface unit 915 by wires 967. The 915 first interface unit 915 may include a power amplifier or it may just be a simple connector. Similarly, the second interface unit 962 may include power amplifier or it may just be a simple connector. Either one of the interface units 915, 967 could also include a biased wire retractor mechanism typically in the form of a spring loaded reel for conveniently storing the wires 967. It is also envisaged that both interface units 915, 967 could include jack-sockets or the like for operative coupling with jack-plugs at ends of the wires 967.

In FIG. 10 there is illustrated is illustrated a perspective view of housing portions 910, 960 of the two-part radio communications device 900, the housing 910, 960 portions being physically detached from each other. The first housing potion 110 has the first speaker 938 mounted therein at a position directly underneath a first speaker grille 1020. There is also a first ear mount in the form of a first ear hook 1025 slidably mounted in the first housing portion 910, the first ear hook 1025 being proximal to the first speaker 938 and grille 1020. The first ear hook 1025 is locatable in a complementary shaped recess 1027 and is movable out of the recess 1027 by a user concurrently pressing and pulling on a lateral shoulder 1026 of the first ear hook 1025. The first ear hook 1025 can be inserted back into the recess 1027 by simply pushing on its outer surface. The second housing portion 960 is releasbly mountable to the first housing portion 910 at a hinge assembly 1030, that provides for allowing relative pivotal movement of the second housing portion 960 relative to the first housing portion 910 (when mounted together) about a pivotal axis X from an opened to a closed position. More specifically the second housing portion 960. is releasbly mountable at the pivotal axis X by spring loaded balls 1010 engaging and disengaging respective sockets 1020 forming part of the hinge assembly 1030.

The second housing potion 960 has the second speaker 981 mounted therein at a position directly underneath a second speaker grille 1050. There is also a second ear mount in the form of a second ear hook 1055 slidably mounted in the second housing portion 960, the second ear hook 855 being proximal to the second speaker 181 and grille 1050. The second ear hook 1055 is locatable in a complementary shaped recess 1057 and is movable out of the recess 1057 by a user concurrently pressing and pulling on a lateral shoulder 1056 of the second ear hook 1055. The second ear hook 1055 can be inserted back into the recess 1057 by simply pushing on its outer surface.

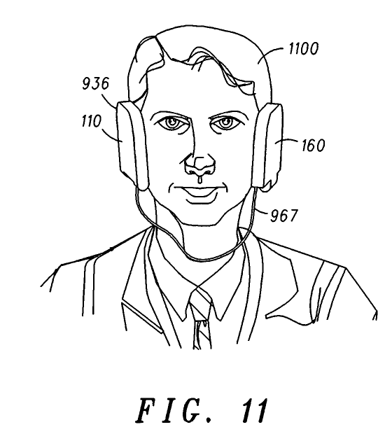

In use, music content stored in the ROM 914 can be played by the device 100 when it is worn by the user 1100 as shown in FIG. 11. Who so worn, the second housing portion 960 is mounted to one ear of the user by the second ear hook 855 and the first housing portion 910 is mounted to the other ear by the first ear hook 1025. Thus stereophonic music can be enjoyed and the user 1100 can adjust the volume and content being played by use of auxiliary controls 936. The content is transferred from ROM 114 to the second speaker 981 in housing portion 960 via the wires 967.

In the foregoing specification, specific embodiments of the present invention have been described. However, one of ordinary skill in the art appreciates that various modifications and changes can be made without departing from the scope of the present invention as set forth in the claims below. For example, although a flip or clamshell device is shown the device could also be a two piece candy-bar device that dose not have two portions pivotally mounted to each other but instead the portions when mounted are in a fixed opened position. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

We claim:

1. A multi-speaker two part electronics device comprising:
a first housing portion with a first speaker mounted therein,
a first ear mount attached to the first housing portion, the first ear mount being proximal to the first speaker, and the first ear mount being shaped to mount the first housing portion to an ear of a user;
a second housing portion releasbly mountable to the first housing portion, the second housing portion having a second speaker mounted therein; and
a second ear mount attached to the second housing portion, the second ear mount being proximal to the second speaker, and the second ear mount being shaped to mount the second housing portion to an ear of the user.

2. A multi-speaker two part electronics device as claimed in claim 1, wherein the first ear mount and second ear mount are located at opposite ends of a housing comprising the first housing portion and second housing portion.

3. A multi-speaker two part electronics device as claimed in claim 2, wherein the first ear mount is a shouldered rim.

4. A multi-speaker two part electronics device as claimed in claim 1, wherein the first ear mount is an ear hook.

5. A multi-speaker two part electronics device as claimed in claim 4, wherein the first ear mount is locatable in a first recess formed in the first housing portion and the second ear mount is locatable in a second recess formed in the second housing portion.

6. A multi-speaker two part electronics device as claimed in claim 1, wherein the second housing portion is releasbly mounted to the first housing portion at a hinge, the hinge allowing for relative pivotal movement of the second housing portion relative to the first housing portion.

7. A multi-speaker two part electronics device as claimed in claim 6, wherein the first ear mount is located at a free end of the first housing portion and the second and second ear mount is located at a free end of the second housing portion.

8. A multi-speaker two part electronics device as claimed in claim 1, wherein the first housing portion has a primary radio frequency communications unit mounted therein, the primary radio frequency communications unit providing wireless communication with a telephone network.

9. A multi-speaker two part electronics device as claimed in claim 1, wherein there is audio signal providing circuitry operatively coupled to the first speaker and second speaker.

10. A multi-speaker two part electronics device as claimed in claim 1, wherein there is a microphone associated with the first housing, the microphone being operatively coupled to the primary radio frequency communications unit.

11. A multi speaker two part electronics device as claimed in claim 1, wherein there is a keypad mounted to the first housing member, the keypad being operatively coupled to the audio signal providing circuitry.

12. A multi-speaker two part electronics device as claimed in claim 1, wherein there is a display screen mounted to the first housing member, the display screen being operatively coupled to the audio signal providing circuitry.

13. A multi-speaker two part electronics device as claimed in claim 1, wherein the first housing portion has a secondary radio frequency communications unit mounted therein; and the second housing portion has a short range radio frequency communications unit mounted therein, the short range radio frequency communications unit providing radio communication with the secondary radio frequency communications unit.

14. A multi-speaker two part electronics device as claimed in claim 1, wherein the secondary radio frequency communications unit is operatively coupled to the audio signal providing circuitry.

15. A multi-speaker two part electronics device comprising:
a first housing portion with a first speaker mounted therein, the first speaker being adjacent an associated first speaker aperture in the first housing,
a first ear hook attached to the first housing portion, the first ear hook at least partially surrounding the first speaker aperture; a second housing portion releasbly mountable to the first housing portion, the second housing portion having a second speaker mounted therein, the second speaker being adjacent an associated second speaker aperture in the second housing; and
a second ear hook attached to the second housing portion, the second ear hook at least partially surrounding the second speaker aperture.

16. A multi-speaker two part electronics device as claimed in claim 15, wherein the first ear hook and second ear hook are located at opposite ends of a housing comprising the first housing portion and second housing portion.

17. A multi-speaker two part electronics device as claimed in claim 15, wherein the first ear hook is locatable in a first recess formed in the first housing portion and the second ear hook is locatable in a second recess formed in the second housing portion.

18. A multi-speaker two part electronics device as claimed in claim 15, wherein the second housing portion is releasbly mounted to the first housing portion at a hinge, the hinge allowing for relative pivotal movement of the second housing portion relative to the first housing portion.

19. A multi-speaker two part electronics device as claimed in claim 15, wherein the first housing portion has a primary radio frequency communications unit mounted therein, the primary radio frequency communications unit providing wireless communication with a telephone network.

20. A multi-speaker two part electronics device as claimed in claim 15, wherein there is audio signal providing circuitry operatively coupled to the first speaker and second speaker.
